(19) United States
(12) Patent Application Publication
(10) Pub. No.: US 2006/0056077 A1
(43) Pub. Date: Mar. 16, 2006

(54) Method for assembling a self-adjusting lens mount for automated assembly of vehicle sensors

(76) Inventor: Donal Johnston, Los Angeles, CA (US)

Correspondence Address: MYERS DAWES ANDRAS & SHERMAN, LLP, 19900 MACARTHUR BLVD.,, SUITE 1150, IRVINE, CA, 92612, US

(21) Appl. No.: 11/202,537

(22) Filed: Aug. 12, 2005

Related U.S. Application Data
(60) Provisional application No. 60/609,977, filed on Sep. 15, 2004.

(51) Int. Cl. G02B 7/02

(52) U.S. Cl. 359/811

(57) ABSTRACT

A method for assembling an imaging system employing an adjustable two piece lens mount system. The method is adapted for automated mounting of a lens in correct focus and alignment relative to a CMOS imaging device such that the optical axis of the lens is coincident with and perpendicular to the center of the active area of the imager array. The lens is secured by the axial pressure of flexible ribs that are symmetrically spaced around the internal bore of a lens holder and act on a smooth surface on the outside of the lens. This arrangement eliminates translation of the lens across the imager array. Another portion of the body of the lens is threaded such that the lens, when rotated about its optical axis is focused or axially aligned. When a focus or axial alignment point is reached, a staking fluid is added to the lens thread, through a hole in the lens holder to prevent de-focusing. The second component of the lens mount system, the lens mount base, is fixedly secured to an imager board on which is mounted a CMOS imager. The upper wall of the lens mount base is mounted in close, parallel proximity to the optical flat of the imager and has a rectangular opening which restricts light from the lens to the active area of the imager, and more specifically prevents light from falling on the column amplifiers of the imaging device. The design of both components is such that they may be moved relative to each other with external fixturing, in front of a known target, until it is decided that the lens is directly over the center of the imager array. The lens holder and the lens mount base are then fixed together permanently using a laser weld process or any other plastic bonding technique.

### RELATED APPLICATION INFORMATION

The present application claims the benefit of U.S. provisional patent application Ser. No. 60/609,977 filed on Sep. 15, 2004, the disclosure of which is incorporated herein by reference in its entirety.

### BACKGROUND OF THE INVENTION

1. Field of the Invention

The present invention relates to methods of assembling vehicle mounted imaging systems for vehicle positioning and safety applications. More particularly, the present invention relates to methods of assembling imaging systems for vehicle mounted lane tracking systems.

2. Description of the Prior Art

Image processing technologies are being designed and implemented for intelligent vehicles that are directed to improving vehicle safety. One significant example of such an image processing based safety system is a lane departure warning system. A typical lane departure warning (LDW) system includes a camera mounted in a vehicle, e.g. in the vehicle's rear-view mirror stalk at the center of the windshield, along with an imager board that includes an imager or camera and image-processing circuitry. The LDW system works by finding the lane markings on the road and then monitoring vehicle position relative to the lane markings. If the system detects a lane change without a turn signal, it sends a feedback signal to the driver to alert drivers who would otherwise unknowingly cross lane markers, for example, an audible ding, buzz or vibration.

Lane departure warning systems use determinations as to the spatial position of the device, and thus the vehicle, based on geometrical features in a stream of video data. The position and orientation of road markings in the image are used to continually calculate the lateral position of the vehicle in the lane in which it is traveling. It is desirable to minimize any misalignment of the image which could lead to video data that yields incorrect determinations of lane position. In particular, a misalignment of the lens relative to the imager could cause the road scene to be translated across the image which could affect the system's estimation of vehicle position.

The ideal position for a lens in an image processing application such as an LDW application is such that the following conditions are met. The lens should be at the correct focus height above the imager, the optical axis of the lens should be perpendicular to the imager array and the optical axis of the lens should be coincident with the center of the image array. Any deviation of these relationships will cause there to be less than ideal conditions for detecting the relevant features in the video image.

When focusing or axially aligning the lens of an optical system to be used in an LDW application, the lens must be accurately constrained relative to the imager such that it's optical axis is perpendicular to the imager plane at all times during and after focusing. However, a common issue for on-board sensors is calibration and alignment of the optical assembly, including the lens and sensor. Traditionally, standard miniature lenses are mounted in one piece lens mounts such that when the lens is rotated in the lens mount, it moves axially to the desired focus point. The inherent looseness of a thread allows for some “pitching” movement of the lens during such focusing. This movement causes the optical axis of the lens to lose its perpendicular alignment to the imager array, which causes the scene to be translated and appear out of focus on one side.

Another source of misalignment that is problematic in conventional approaches to aligning lens assemblies in image processing applications is a translational misalignment of the lens optical axis across the imager array. This type of misalignment is termed an X-Y offset because the optical axis will be offset from the center of the imager pixel array by a number rows (Y offset) and columns (X offset). In a complementary metal oxide semiconductor (CMOS) system, the following elements contribute to this offset: the location of the imager package on the imager board to which it is soldered, the location of the imager wafer within the imager package, the position tolerance of the holes on the imager board that locate the lens mount, the lens mount part tolerances, and the internal lens tolerances or eccentricity between mechanical and optical axes.

Accordingly, a need presently exists for an improved system and method for mounting a lens and imager assembly in a system adapted for vehicle safety applications. More particularly, a need exists for an improved lens mounting system which may be advantageously employed in a system for detecting lane markers in a roadway which can provide accurate lane marker detection and eliminate the X-Y offset while maintaining the perpendicularity of the optical axis to the imager array.

### SUMMARY OF THE INVENTION

In a first aspect the present invention provides a method for assembling an imaging system employing an adjustable lens mount system. The method comprises mounting a lens mount base to an imager board having an imager mounted thereon, the imager having an active area with an optical flat surface. The lens mount base has a back side facing the imager board and a front side opposite the imager board. The method further comprises inserting a lens in a lens holder, the lens having an optical axis, and engaging the lens holder with the front side of the lens mount base without affixing the lens holder to the lens mount base. The method further comprises moving the lens within the lens holder along the direction of the optical axis to focus the lens relative to the imager. The method further comprises translating the lens holder relative to the lens mount base parallel to the optical flat surface of the imager until the optical axis is centered over the center of the active area of the imager and then affixing the lens holder to the lens mount base.

In a preferred embodiment the front side of the lens mount base comprises a flat surface for receiving the lens holder which is parallel with the optical flat surface of the imager, and engaging the lens holder with the front side of the lens mount base comprises engaging the lens holder with the flat surface of the lens mount base. Translating the lens holder relative to the lens mount base parallel to the optical flat surface of the imager preferably comprises translating the lens holder relative to the lens mount base while maintaining the lens holder in contact with the flat surface of the lens mount base. The front side of the lens mount base may further comprise a track and the first end of the lens holder includes a plate that is adapted to slide in the track while allowing relative motion parallel to the flat surface of the lens mount base, and engaging the lens holder with the front side of the lens mount base without affixing the lens holder to the lens mount base comprises engaging the plate within the track in contact with the flat surface of the lens mount base. The track on the front side of the lens mount base may be defined by a tab spaced apart from the flat surface of the lens mount base. The lens and lens holder may have threads which are engaged when the lens is inserted into the lens holder and moving the lens within the lens holder along the direction of the optical axis to focus the lens comprises rotating the lens in the lens holder to translate the lens along the optical axis. The method also preferably comprises affixing the axial position of the lens in the lens holder after performing the focusing. For example, the holder may have an opening over the threads of the lens and affixing the axial position of the lens in the lens holder after performing the focusing may comprise placing a staking fluid in the opening to prevent rotation of the lens in the lens holder. The lens mount base preferably further includes a rectangular opening in the back side thereof dimensioned the same as the active area of the imager in the imager board and mounting a lens mount base to an imager board comprises aligning the rectangular opening over the active area of the imager in sufficient proximity to restrict light to only the active area of the imager. The imager may comprise a CMOS imaging device. The method preferably further comprises monitoring the imager detection of a fixed target during the translating step to determine when the optical axis is aligned with the center of the imager. One or more of the mounting, inserting, engaging, moving, translating and affixing steps may be automated.

According to another aspect the present invention provides a method for assembling an imaging system, comprising mounting a lens mount base to an imager board having an imager mounted thereon, the imager having an active area with an optical flat surface, and engaging a lens holder with the lens mount base, the lens holder having a body portion with an inner bore, the bore having a surface threaded on a portion thereof and an unthreaded portion, and axial alignment means configured within the unthreaded portion of the bore. The method further comprises inserting a lens in the lens holder in an unfocused position, the lens having an optical axis and a cylindrical barrel, the barrel including a threaded surface and an unthreaded surface, such that the threaded surface of the lens barrel engages the threaded surface of the bore, and the axial alignment means engages the unthreaded surface of the lens barrel. The method further comprises moving the lens within the lens holder along the direction of the optical axis to focus the lens relative to the imager while maintaining alignment of the optical axis of the lens perpendicular to the optical flat surface of the imager using the axial alignment means.

In a preferred embodiment moving the lens within the lens holder along the direction of the optical axis to focus the lens comprises rotating the lens within the lens holder. The method also preferably further comprises affixing the axial position of the lens in the lens holder after performing the focusing. For example, the lens holder may have an opening over the threads of the lens and affixing the axial position of the lens in the lens holder after performing the focusing comprises placing a staking fluid in the opening to prevent rotation of the lens in the lens holder. The axial alignment means preferably comprises plural flexible ribs configured symmetrically about the axis within the inner bore of the lens holder, and maintaining alignment of the optical axis of the lens perpendicular to the optical flat surface of the imager using the axial alignment means comprises axially aligning the lens by the axial pressure of the ribs. The method may further comprise translating the lens holder relative to the lens mount base in a direction perpendicular to the optical axis of the lens until the optical axis is centered over the center of the active area of the imager. The method may further comprise affixing the lens holder to the lens mount base after the translating step. One or more of the mounting, engaging, inserting, moving, translating and affixing step may be automated.

Further features and aspects of the invention are disclosed in the following detailed description.

### BRIEF DESCRIPTION OF THE DRAWINGS

FIG. 1 is a drawing of a vehicle employing an imaging system employing the lens mounting system of the present invention.

FIG. 2 is an exploded view of the imaging system illustrating a preferred embodiment of the lens mount system of the present invention.

FIG. 3 is a preferred embodiment of a lens mount base according to the present invention.

FIG. 4 is a preferred embodiment of a lens holder according to the present invention.

FIG. 5 is a preferred embodiment of a lens adapted to be used with the lens mount system according to the present invention.

FIG. 6 is a proximal view of a preferred embodiment of the lens holder with the lens assembled within it, according to the present invention.

FIG. 7 is a preferred embodiment of the lens mount system assembled with an imager board, according to the present invention.

### DETAILED DESCRIPTION OF THE INVENTION

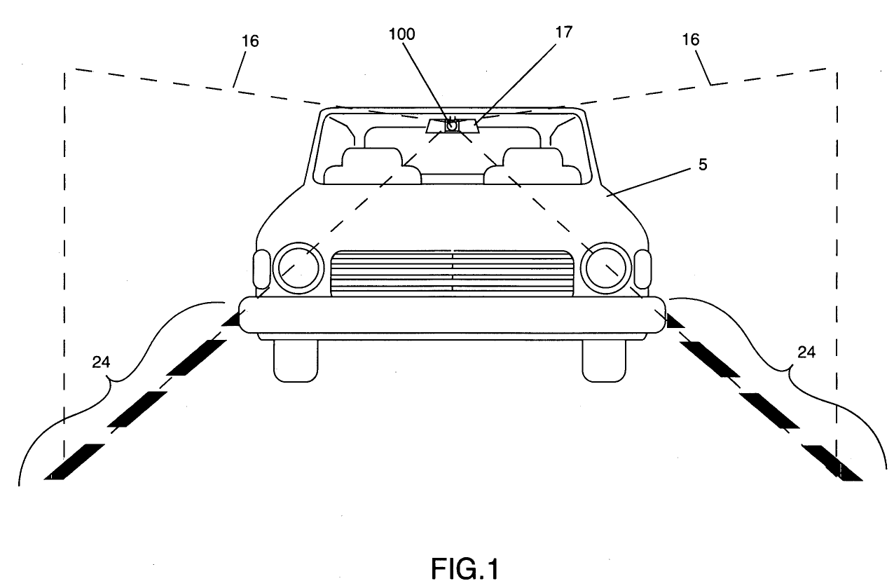

FIG. 1 illustrates a vehicle 5 employing an imaging system 100 with a lens mount system in accordance with a preferred embodiment of the present invention. The imaging system 100 may form part of a lane departure warning system in one preferred application. Imaging system 100 employs at least one camera on the stem of the rear-view mirror 17. Other locations and additional cameras may also be employed, however, as described in U.S. patent application Ser. No. 10/373,150 filed Feb. 24, 2003, the disclosure of which is incorporated herein by reference in its entirety. The imaging system 100 is oriented generally along the direction of vehicle travel. As a result, the imaging system 100 provides a field of view 16 oriented forward along the roadway to include a portion of the roadway including lane markers 24. The lens mount system of the present invention improves alignment accuracy to improve the accuracy of the imaging system 100 in imaging lane markers 24 in a lane departure warning application. Similarly, the present invention may improve accuracy of the imaging system in other applications.

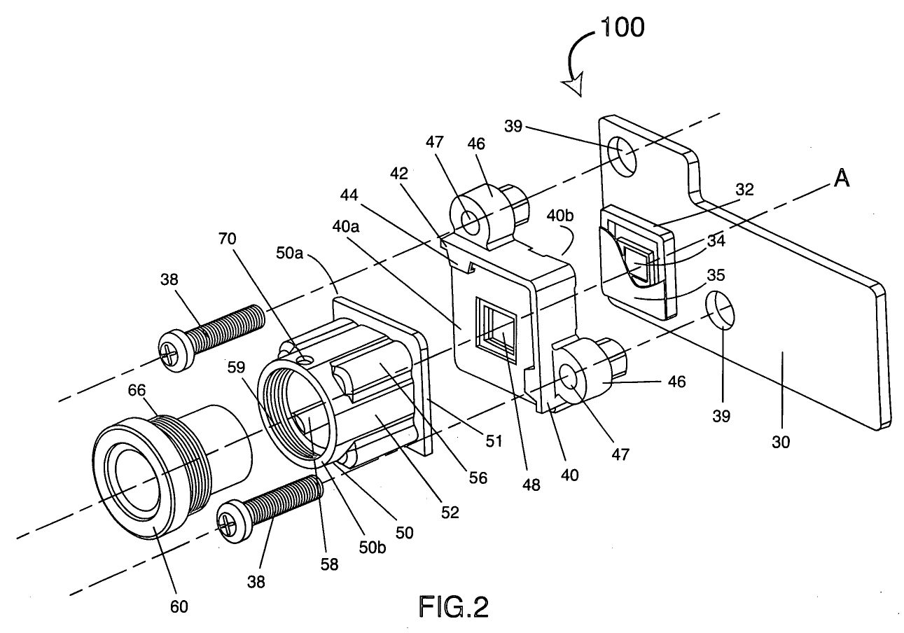

As best illustrated in FIG. 2, the imaging system 100 includes an imager board 30, a lens mount system comprising two separately adjustable lens mount sections, and a lens. More specifically, the lens mount system includes a lens mount base 40, and a lens holder 50 having a first proximal end 50a and a second distal end 50b. The second end of the lens holder has an opening which receives a lens 60. The lens mount base is adapted to be coupled to imager board 30, on which is mounted a camera or imager 32, for example, a CMOS imager. The imager 32 includes an active area comprising a rectangular pixel array 34 and a transparent cover 35. The active area 34 defines an optical flat surface. The lens 60 has an optical axis A. The lens mount system of the present invention aligns the optical axis A to be perpendicular to the optical flat surface of the imager and aligned to the center of the pixel array.

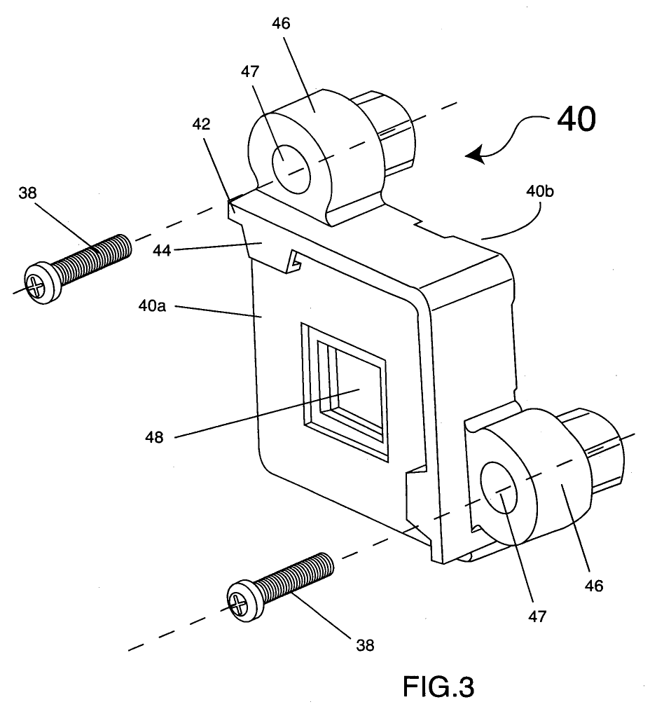

As best illustrated in FIG. 2 and FIG. 3, the lens mount base 40 includes a wall portion having a front side 40a opposite to the imager board and a back side 40b adjacent to and facing the imager board. The wall portion has a flat surface comprising some or all of front side 40a which is parallel to the optical flat surface of the imager 32 (for convenience reference numeral 40a will be used for this flat surface as well as the front side of the lens mount base generally). In a preferred embodiment, the base 40 receives lens holder 50 on the flat surface 40a and includes a lip 42 that acts like a track for guiding the lens holder 50 during X-Y adjustment (adjustment parallel to the optical flat surface of imager 32). In a preferred embodiment, the lip 42 includes one or more tabs 44 spaced from flat front surface 40a so as to define engagement slots for holding the lens holder 50 firmly against the flat front surface 40a of the base 40 while allowing X-Y movement of the lens holder 50. As described further below, the first end 50a of lens holder 50 has a portion, for example a flat plate 51, having a shape adapted to fit within these engagement slots and contact the flat surface of the lens mount base so as to maintain a parallel relation with the flat surface of the lens mount base during the X-Y movement of the lens holder 50. In a preferred embodiment, the base 40 includes a small rectangular opening 48 in the wall portion, dimensioned and positioned to restrict light from the lens 60 to fall only on the active area 34 of the imager 32. The rectangular opening 48 in this way prevents light from falling on column amplifiers adjacent active area 34 of imager 32. The configuration of such column amplifiers in a typical CMOS imager and the importance of blocking light to such amplifiers are described in U.S. Pat. No. 6,198,087 the disclosure of which is incorporated herein by reference in its entirety. The base 40 further includes means for mounting the base to the imager board. In a preferred embodiment, two or more offset ears 46 may be provided with protrusions which couple into apertures 39 in the imager board 30 (shown in FIG. 2) to align the base opening 48 over the active area 34 of imager 32. Offset ears 46 may be provided with apertures 47 for receiving screws 38 that extend through imager board 30 and engage a threaded opening in rear-view mirror 17 or other mounting position to hold the imaging system 100 in place. Various other mounting means may be employed, however, depending on the particular application.

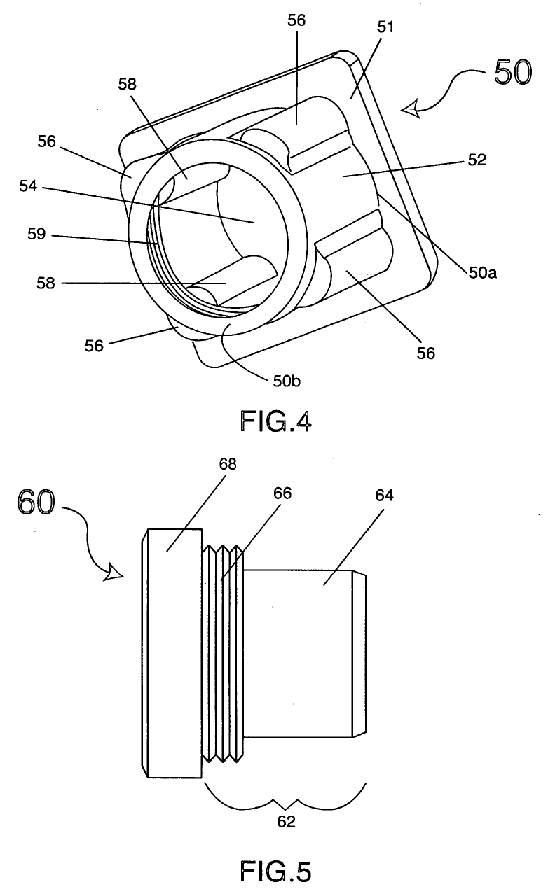

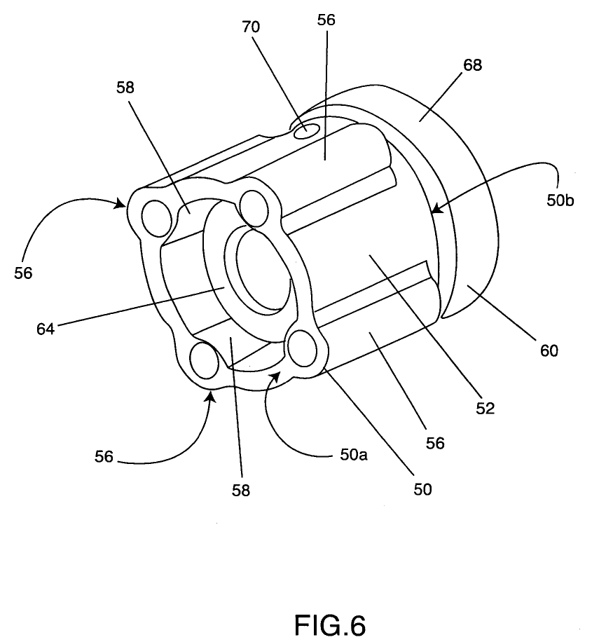

As best illustrated in FIG. 2 and FIG. 4, the lens holder 50 includes a main body 52 that is integrally formed with or coupled to a flat plate 51 at the first end 50a which plate is adapted to couple to the front side of the lens mount base described above. The second end 50b of the lens holder has an opening for receiving the lens, and the body 52 has an inner space or inner bore that is substantially cylindrical in shape with a central axis extending from the opening. When the lens 60 is inserted into the bore this central axis will align with the optical axis A of the lens as shown in FIG. 2. The inner bore has a first threaded portion 59 that is adapted to receive the threads 66 on lens 60 (shown in FIG. 2 and FIG. 5). The inner bore has a second unthreaded portion which includes axial alignment means for maintaining the lens aligned with the central axis of the bore during focusing adjustment along the axial direction. For example, the axial alignment means may comprise flexible ribs 58 symmetrically configured about the axis of the bore. In a preferred embodiment, four (4) flexible ribs 58 symmetrically distributed within the inner space 54. More or fewer ribs 58 may be provided, however. Flexible ribs 58 may be provided in a variety of ways. For example, body 52 may comprise a hard-shelled plastic casing having outer protrusions 56 extending therefrom that receive flexible ribs 58 which may be generally cylindrical inserts of rubber, foam or other flexible material. Alternatively, the flexible alignment ribs 58 may comprise thinner walled portions of the plastic material integrally formed with body 52. Also, other implementations of the axial alignment means may be employed. For example, a continuous axially symmetric sleeve of flexible material may be employed.

As best illustrated in FIG. 2 and FIG. 5, the lens 60 comprises a lens barrel 62 that has an unthreaded surface 64 along the majority of its length that engages ribs 58 in lens holder 50. The lens barrel 62 also includes a threaded portion 66 that is adapted to engage the threading 59 of lens holder 50 when rotated about its optical axis A to axially move lens 60 along axis A when the lens 60 is focused. The lens 60 further includes a protruding overhang 68 that holds a conventional glass lens.

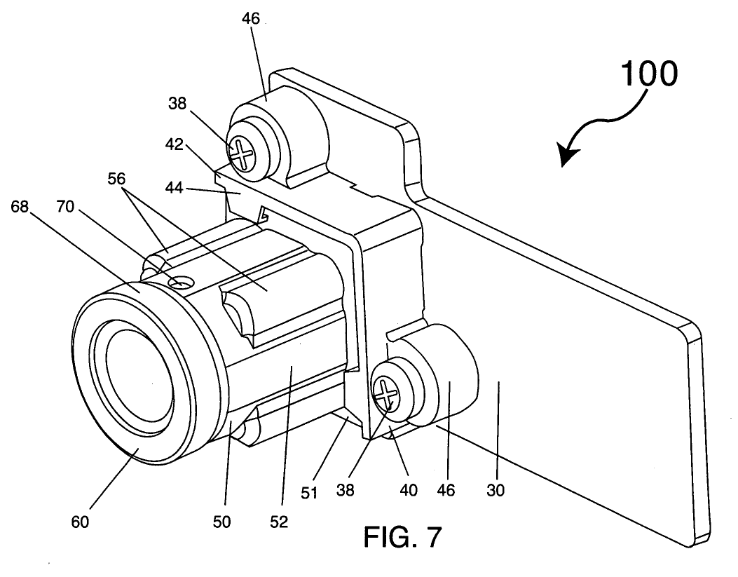

FIG. 6 illustrates a section through lens holder 50 showing the engagement between the lens 60 and the lens holder 50 viewed from the direction of the first proximal end of the holder 50. As shown, the lens barrel 62 enters the holder 50 from the distal end 50b and is threaded into place via the threading 59, 66. The unthreaded surface 64 of the barrel 66 engages with the flexible ribs 58 within the second portion of inner bore 54 of the lens holder 50. This engagement maintains a constant axially symmetric radial pressure on the lens 60 so that it is accurately constrained relative to the optical flat surface of imager 32 (shown in FIG. 2) such that its optical axis A is perpendicular to the imager plane at all times during and after focusing. The completely assembled imager and lens assembly is shown in FIG. 7.

According to another aspect of the invention, a method is disclosed for assembling the image system 100 using the above described lens mount system. In a preferred embodiment the invention allows for automated adjustment of the position of the lens, relative to imager 32 with feedback from a fixed target that has features in known positions. The lens holder flexible ribs prevent tilting of the lens during axial movement of the lens during focusing. The two piece lens module in turn allows for the lens to be translated across the imager array until the X-Y offset is eliminated by allowing the lens holder and lens mount base to be moved relative to each other while maintaining the perpendicularity of the optical axis to the imager array.

More specifically, referring to FIGS. 2-7, in a preferred embodiment, the lens mount base 40 is first attached to the printed circuit board (PCB) or imager board 30 generally over imager array 34 using suitable mounting means, such as ears 46 with protrusions that couple to openings 39 in the imager board, so that rectangular opening 48 is aligned over active area 34 of imager 32. The wall containing opening 48 is brought sufficiently close to the imager 32 to block light from the column amplifiers in the case where a CMOS imager with conventional read out circuitry is employed for imager 32. A monitor is coupled to the imager output to detect a fixed target, both of which may be conventional and are not shown. The lens 60 is then inserted into the lens holder 50 and held in place in an initial unfocused position via flexible ribs 58 and threading as generally shown in FIG. 6. The lens holder with lens is then brought into contact with the lens mount base with the plate 51 of the lens holder flush with flat surface 40a of lens mount base. This step may be done manually or may be automated. In an automated implementation of the method, the lens 60 and lens mount 50 may be held flush to the lens mount base 40 with a conventional automated fixture (not shown). Next, the lens 60 is screwed into the lens mount 50 using the threads 59, 66 until imager readout is focused. Ribs 58 keep the lens 60 axially aligned to minimize the effect of any “pitching” movement of the optical axis of lens 60. Although constrained by the ribs, the lens is still sufficiently loose to be focused within the lens mount using the threaded portion of the lens and the lens holder in a traditional manner. After focusing the lens is locked in place at the focus point with the application of a suitable staking fluid such as an epoxy introduced via aperture 70 in the lens holder that is in communication with the threads of the lens. Alternatively, other known methods of affixing the two pieces may be employed.

The fixed assembly of lens 60 and lens holder 50 is then moved parallel to the flat surface 40a of lens mount base 40 and optical flat surface of imager 32 (and in a perpendicular direction to optical axis A) while maintaining lens holder 50 in contact with the surface of lens mount base 40. Preferably parallel movement is controlled via tabs 44 located on the base 40. Shown best in FIG. 2 and FIG. 7, the back plate 51 of the holder 50, aligns with the lip 42 of the base 40 and slides within it. The tabs 44 hold the back plate 51 parallel to the surface 40a of lens mount base 40. In an automated embodiment a fixture may be used to accurately move the lens holder flush with the flat surface of lens mount base and lip 42 and tabs 44 may be dispensed with. The lens mount 50 is slid within base 40 until the optical axis A of the lens is over the exact center of the imager array, which is determined using a video image of the target. This allows the removal of residual X-Y offset axis A of lens 60 with the center of pixel array 34 due to inaccuracies in the various optical and mechanical components and mechanical assembly steps. The lens mount base and lens holder parts are then bonded together with a suitable plastic bonding means to permanently maintain this alignment. For example, laser welding may be employed. Alternatively, other known methods of affixing the two pieces may be employed.

In view of the above it will be appreciated that the lens mount system is well adapted for automated and accurate assembly. The design of the components of the lens mount system is such that they may be moved relative to each other with external fixturing, in front of a known target, until it is decided that the lens is directly over the center of the imager array. With the target and assembly fixtures, it can be determined that the lens is correctly aligned with the imager, as is desired for optimal detection of the relevant features in the video image.

Many alterations and modifications may be made by those having ordinary skill in the art without departing from the spirit and scope of the invention. For example, a variety of different materials and configurations may be employed for the different components of the lens mount system. Also, alterations in the order of the assembly steps may be provided depending on the preferred implementation and whether manual or automated assembly is employed. Additional modifications too numerous to mention will be appreciated by those skilled in the art.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention. Also, while the apparatus and method has or will be described for the sake of grammatical fluidity with functional explanations, it is to be expressly understood that the claims, unless expressly formulated under 35 USC 112, last paragraph, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112.

What is claimed is:

1. A method for assembling an imaging system employing an adjustable lens mount system, comprising:
mounting a lens mount base to an imager board having an imager mounted thereon, the imager having an active area with an optical flat surface, and the lens mount base having a back side facing the imager board and a front side opposite the imager board;
inserting a lens in a lens holder, the lens having an optical axis;
engaging the lens holder with the front side of the lens mount base without affixing the lens holder to the lens mount base;
moving the lens within the lens holder along the direction of the optical axis to focus the lens relative to the imager;
translating the lens holder relative to the lens mount base parallel to the optical flat surface of the imager until the optical axis is centered over the center of the active area of the imager; and
affixing the lens holder to the lens mount base.

2. The method for assembling an imaging system of claim 1, wherein the front side of the lens mount base comprises a flat surface for receiving the lens holder which is parallel with the optical flat surface of the imager, and wherein engaging the lens holder with the front side of the lens mount base comprises engaging the lens holder with said flat surface of the lens mount base.

3. The method for assembling an imaging system of claim 2, wherein translating the lens holder relative to the lens mount base parallel to the optical flat surface of the imager comprises translating the lens holder relative to the lens mount base while maintaining the lens holder in contact with said flat surface of the lens mount base.

4. The method for assembling an imaging system of claim 3, wherein the front side of the lens mount base further comprises a track and wherein the first end of the lens holder includes a plate that is adapted to slide in the track while allowing relative motion parallel to the flat surface of said lens mount base, and wherein engaging the lens holder with the front side of the lens mount base without affixing the lens holder to the lens mount base comprises engaging said plate within said track in contact with the flat surface of said lens mount base.

5. The method for assembling an imaging system of claim 4, wherein said track on the front side of the lens mount base is defined by a tab spaced apart from said flat surface of the lens mount base.

6. The method for assembling an imaging system of claim 1, further comprising affixing the axial position of said lens in said lens holder after performing said focusing.

7. The method for assembling an imaging system of claim 6, wherein the lens and lens holder have threads which are engaged when said lens is inserted into the lens holder and wherein moving the lens within the lens holder along the direction of the optical axis to focus the lens comprises rotating the lens in the lens holder to translate the lens along the optical axis.

8. The method for assembling an imaging system of claim 7, wherein the holder has an opening over the threads of the lens and wherein affixing the axial position of said lens in said lens holder after performing said focusing comprises placing a staking fluid in said opening to prevent rotation of the lens in the lens holder.

9. The method for assembling an imaging system of claim 1, wherein the lens mount base further includes a rectangular opening in the back side thereof dimensioned the same as the active area of the imager in the imager board and wherein said mounting a lens mount base to an imager board comprises aligning the rectangular opening over the active area of the imager in sufficient proximity to restrict light to only said active area of the imager.

10. The method for assembling an imaging system of claim 9, wherein the imager comprises a CMOS imaging device.

11. The method for assembling an imaging system of claim 1, further comprising monitoring the imager detection of a fixed target during said translating to determine when said optical axis is aligned with the center of the imager.

12. The method for assembling an imaging system of claim 1, wherein one or more of said mounting, inserting, engaging, moving, translating and affixing are automated.

13. A method for assembling an imaging system employing an adjustable lens mount system, comprising:
mounting a lens mount base to an imager board having an imager mounted thereon, the imager having an active area with an optical flat surface;
engaging a lens holder with the lens mount base, the lens holder having a body portion with an inner bore, the bore having a surface threaded on a portion thereof and an unthreaded portion, and axial alignment means configured within the unthreaded portion of the bore;
inserting a lens in the lens holder in an unfocused position, the lens having an optical axis and a cylindrical barrel, the barrel including a threaded surface and an unthreaded surface, wherein the threaded surface of the lens barrel engages the threaded surface of the bore, and wherein the axial alignment means engages the unthreaded surface of the lens barrel; and
moving the lens within the lens holder along the direction of the optical axis to focus the lens relative to the imager while maintaining alignment of the optical axis of the lens perpendicular to the optical flat surface of the imager using said axial alignment means.

14. The method for assembling an imaging system of claim 13, wherein moving the lens within the lens holder along the direction of the optical axis to focus the lens comprises rotating the lens within the lens holder.

15. The method for assembling an imaging system of claim 13, further comprising affixing the axial position of said lens in said lens holder after performing said focusing.

16. The method for assembling an imaging system of claim 15, wherein the lens holder has an opening over the threads of the lens and wherein affixing the axial position of said lens in said lens holder after performing said focusing comprises placing a staking fluid in said opening to prevent rotation of the lens in the lens holder.

17. The method for assembling an imaging system of claim 13, wherein the axial alignment means comprises plural flexible ribs configured symmetrically about the axis within the inner bore of the lens holder, and wherein maintaining alignment of the optical axis of the lens perpendicular to the optical flat surface of the imager using said axial alignment means comprises axially aligning the lens by the axial pressure of the ribs.

18. The method for assembling an imaging system of claim 13, further comprising translating the lens holder relative to the lens mount base in a direction perpendicular to the optical axis of the lens until the optical axis is centered over the center of the active area of the imager.

19. The method for assembling an imaging system of claim 18, further comprising affixing the lens holder to the lens mount base after said translating.

20. The method for assembling an imaging system of claim 19, wherein one or more of said mounting, engaging, inserting, moving, translating and affixing are automated.
